(19) United States
(12) Patent Application Publication
(10) Pub. No.: US 2007/0112867 A1
(43) Pub. Date: May 17, 2007

(54) Methods and apparatus for rank-based response set clustering

(75) Inventors: David A. Evans, Pittsburgh, PA (US); Victor M. Sheftel, Bethel Park, PA (US); Jeffrey K. Bennett, Pittsburgh, PA (US); David A. Hull, Pittsburgh, PA (US)

Correspondence Address: JONES DAY, 222 East 41st Street, New York, NY, 10017-6702, US

(73) Assignee: Clairvoyance Corporation, Pittsburgh, PA (US)

(21) Appl. No.: 11/272,784

(22) Filed: Nov. 15, 2005

(51) Int. Cl. G06F 17/30

(52) U.S. Cl. 707/200

(57) ABSTRACT

A method for identifying clusters of similar documents from among a set of documents is described. A particular document is selected based on rank from among a ranked set of documents, wherein the ranked set of documents are included among available documents of the set of documents. A probe is generated based on the particular document. The probe comprising one or more features. Documents that satisfy a similarity condition are found from among the available documents using a search based upon the probe. Some or all documents found are associated with a particular cluster of documents. The process can be repeated to generate further clusters. The method can be implemented with a computer, and associated programming instructions can be contained within a compute readable carrier.

### BACKGROUND

1. Field of the Invention

The present disclosure relates to computerized analysis of documents, and in particular, to identifying clusters of similar documents from among a set of documents.

2. Background Information

Rapid growth in the quantity of unstructured electronic text has increased the importance of efficient and accurate document clustering. By clustering similar documents, users can explore topics in a collection without reading large numbers of documents. Organizing search results into meaningful flat or hierarchical structures can help users navigate, visualize, and summarize what would otherwise be an impenetrable mountain of data.

Hierarchical (agglomerative and divisive) clustering methods are known. Hierarchical agglomerative clustering (HAC) starts with the documents as individual clusters and successively merges the most similar pair of clusters. Hierarchical divisive clustering (HDC) starts with one cluster of all documents and successively splits the least uniform clusters. A problem for all HAC and HDC methods is their high computational complexity (O(n²) or even O(n³)), which makes them unscaleable in practice.

Partitional clustering methods based on iterative relocation are also known. To construct K clusters, a partitional method creates all K groups at once and then iteratively improves the partitioning by moving documents from one group to another in order to optimize a selected criterion function. Major disadvantages of such methods include the need to specify the number of clusters in advance, assumption of uniform cluster size, and sensitivity to noise.

Density-based partitioning methods for clustering are also known. Such methods define clusters as densely populated areas in a space of attributes, surrounded by noise, i.e., data points not contained in any cluster. These methods are targeted at primarily low-dimensional data.

Despite these and other clustering approaches known from the literature, efficient and accurate document clustering of large collections of documents remains a challenging task.

### SUMMARY

It is an object of the invention to produce precise, meaningful clusters of similar documents.

It is another object of the invention to be able to cluster large collections of documents in a reasonable time.

It is another object of the invention to be able to generate a meaningful label, summary or other type of cluster content identifier.

According to one aspect, a method for identifying clusters of similar documents from among a set of documents comprises: (a) selecting a particular document based on rank from among a ranked set of documents; (b) generating a probe based on the particular document, the probe comprising one or more features; (c) finding documents that satisfy a similarity condition from among available documents of the set of documents using a search based upon the probe; and (d) associating some or all documents found with a particular cluster of documents. The method also comprises repeating steps (a)-(d) using another probe as the probe and using another similarity condition as the similarity condition until a halting condition is satisfied to identify at least one other cluster of documents. Those documents of the set of documents previously associated with a cluster of documents are not included among the available documents.

According to another aspect an apparatus comprises a memory and a processor coupled to the memory, wherein the processor is configured to execute the above-noted method.

According to another aspect, a computer readable carrier comprises processing instructions adapted to cause a processor to execute the above-noted method.

### BRIEF DESCRIPTION OF THE FIGURES

FIG. 1 illustrates an exemplary flow diagram for identifying clusters of similar documents according to one aspect of the invention.

FIG. 2 illustrates another exemplary flow diagram for identifying clusters of similar documents according to one aspect of the invention.

FIG. 3 another exemplary flow diagram for identifying clusters of similar documents according to one aspect of the invention.

FIG. 4 illustrates an exemplary block diagram of a computer system on which exemplary approaches for identifying clusters of similar documents can be implement according to another aspect of the invention.

### DETAILED DESCRIPTION

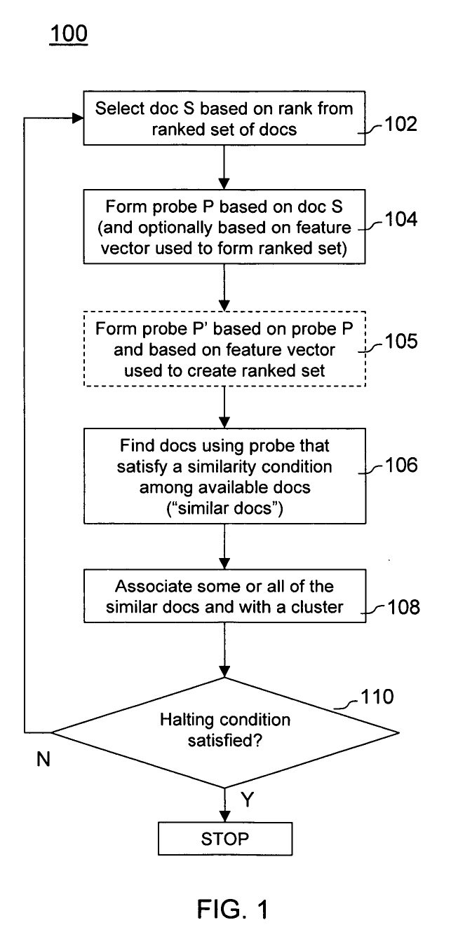

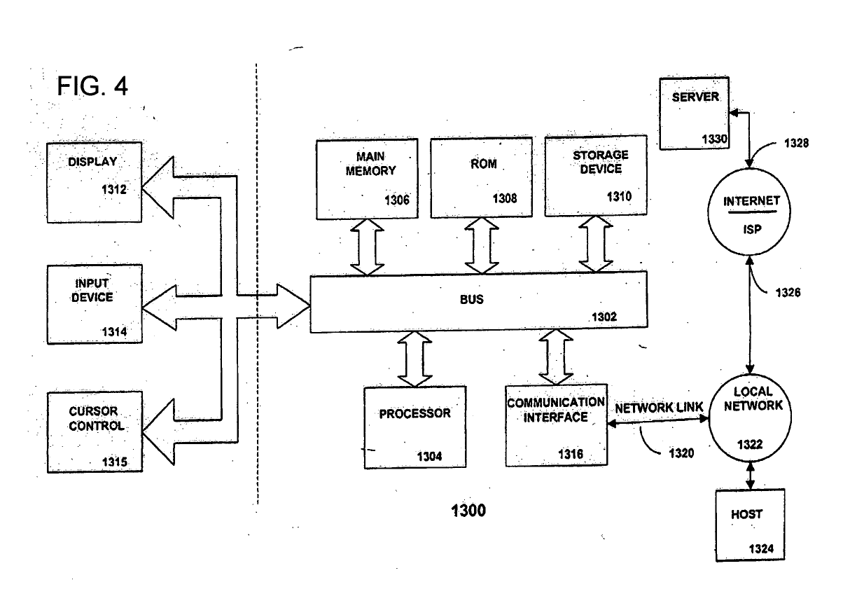

FIG. 1 illustrates an exemplary method 100 for identifying clusters of similar documents from among a set of documents. A cluster can be considered a collection of documents associated together based on a measure of similarity, and a cluster can also be considered a set of identifiers designating those documents. The exemplary method 100, and other exemplary methods described herein, can be implemented using any suitable computer system comprising a processor and memory, such as will be described later in connection with FIG. 4.

A document as referred to herein includes text containing one or more strings of characters and/or other distinct features embodied in objects such as, but not limited to, images, graphics, hyperlinks, tables, charts, spreadsheets, or other types of visual, numeric or textual information. For example, strings of characters may form words, phrases, sentences, and paragraphs. The constructs contained in the documents are not limited to constructs or forms associated with any particular language. Exemplary features can include structural features, such as the number of fields or sections or paragraphs or tables in the document; physical features, such as the ratio of “white” to “dark” areas or the color patterns in an image of the document; annotation features, the presence or absence or the value of annotations recorded on the document in specific fields or as the result of human or machine processing; derived features, such as those resulting from transformation functions such as latent semantic analysis and combinations of other features; and many other features that may be apparent to ordinary practitioners in the art.

Also, a document for purposes of processing can be defined as a literal document (e.g., a full document) as made available to the system as a source document; sub-documents of arbitrary size; collections of sub-documents, whether derived from a single source document or many source documents, that are processed as a single entity (document); and collections or groups of documents, possibly mixed with sub-documents, that are processed as a single entity (document); and combinations of any of the above. A sub-document can be, for example, an individual paragraph, a predetermined number of lines of text, or other suitable portion of a full document. Discussions relating to sub-documents may be found, for example, in U.S. Pat. Nos. 5,907,840 and 5,999,925, the entire contents of each of which are incorporated herein by reference.

In the example of FIG. 1, a particular document (referred to as “doc S” for convenience) is selected based on rank from a ranked set of documents at step 102. The ranked set of documents (e.g., a ranked list) can be obtained in any suitable way. For example, the ranked set could be generated from any suitable query over any source of documents that generates scores for responsive documents. The ranked set of documents can be chosen, for example, from the set of documents from which clusters will be generated, e.g., based upon any suitable query over the set of documents, or could be chosen from a source of documents other than the set of documents to be clustered (such that the ranked set of documents is not among the set of documents to be clustered). The query could be carried out over a single database or multiple databases, and could be carried out over distributed sources of documents such as via the Internet using any suitable search engine. Alternatively, the ranked set could be a set of documents hand-picked by a person and ranked in some order of preference from most relevant to least relevant. The particular document S could be selected as the highest ranking of those documents, or from another position in the ranked order (e.g., from a predetermined score range centered at or above the mean), for example.

At step 104, a probe P is generated based on the particular document S. The probe can comprise one or more features and can be generated in any suitable manner. For example, the probe can comprise the document S itself, e.g., the terms from the text of the document S, possibly combined with any other features of the document S such as described elsewhere herein. As another example, the probe can comprise a subset of features selected from the particular document S, such as a weighted (or non-weighted) combination of features (e.g., terms) of the particular document S. As another example, the probe can comprise a subset of features selected from multiple documents (including the particular document S), such as a weighted (or non-weighted) combination of features (e.g., terms) of the multiple documents.

Also, as reflected at step 104 the probe P can optionally be formed based both the document S and based on a feature vector used to form the ranked set. A feature vector can be, for example, some or all of the features (e.g., terms) of a query used to generated the ranked set of documents. For example, the probe P could be a combination (e.g., a weighted combination) of some or all of the features (e.g., terms) of the document S and some or all of the features (e.g., terms) of the feature vector. It will be appreciated by ordinary practitioners in the art that many approaches could be used to form the probe P based on the document S and based on a feature vector used to form the ranked set.

As a general matter forming a suitable probe based on one or more documents can be accomplished by identifying features of the document(s), scoring the features, and selecting certain features (possibly all) based on the scores. Stated differently, probe formation can be viewed as a process that creates a probe P from a document set {D} (one or more documents) using a method M that specifies how to identify or features in documents and how to score or weight such terms or features, wherein the probe satisfies a test T that determines whether the probe should be formed at all and, if so, which features or terms the probe should include. Identifying distinct features of a document (or documents) and selecting all or a subset of such features for forming a probe is within the purview of ordinary practitioners in the art. For example, parsing document text to identify phrases of specified linguistic type (e.g., noun phrases), identifying structural features (such as the number of fields or sections or paragraphs or tables in the document), identifying physical features (such as the ratio of “white” to “dark” areas or the color patterns in an image of the document), identifying annotation features, including the presence or absence or the value of annotations, are all known in the art. Once such features are identified they can be scored using methods known in the art. One example is simply to count the number occurrences of a given identified feature, and to normalize each number of occurrences to the total number of occurrences of all identified features, and to set the normalized value to be the score of that feature. Depending upon the scores of the identified features, it may be decided not to form the probe at all based upon a given document or documents (e.g., because all of the scores or a combination of the scores fall below a threshold). Selection of a subset of features can be done, for example, by selecting those features that score above a given threshold (e.g., above the average score of the identified features) or by selecting a predetermined number (e.g., 10, 20, 50, 100, etc.) of highest scoring features. Other examples could be used as will be appreciated by ordinary practitioners in the art. Once the subset of features is selected, those features can be weighted, if desired, by renormalizing the number of occurrences a given feature to the total number of occurrences for the features of the subset, thereby providing a probe.

As suggested above, one exemplary subset of features (from one document or from multiple documents) to use as a probe can be a term profile of textual terms, such as described, for example, in U.S. Patent Application Publication No. 2004/0158569 to Evans et al., filed Nov. 14, 2003, the entire contents of which are incorporated herein by reference. One exemplary approach for generating a term profile is to parse the text and treat any phrase or word in a phrase of a specified linguistic type (e.g., noun phrase) as a feature. Such features or index terms can be assigned a weight by one of various alternative methods known to ordinary practitioners in the art. As an example, one method assigns to a term “t” a weight that reflects the observed frequency of t in a unit of text (“TF”) that was processed times the log of the inverse of the distribution count of t across all the available units that have been processed (“IDF”). Such a “TF-IDF” score can be computed using a document as a processing unit and the count of distribution based on the number of documents in a database in which term t occurs at least once. For any set of text (e.g., from one document or multiple documents) that might be used to provide features for a profile, the extracted features may derive their weights by using the observed statistics (e.g., frequency and distribution) in the given text itself. Alternatively, the weights on terms of the set of text may be based on statistics from a reference corpus of documents. In other words, instead of using the observed frequency and distribution counts from the given text, each feature in the set of text may have its frequency set to the frequency of the same feature in the reference corpus and its distribution count set to the distribution count of the same feature in the reference corpus. Alternatively, the statistics observed in the set of text may be used along with the statistics from the reference corpus in various combinations, such as using the observed frequency in the set of text, but taking the distribution count from the reference corpus. The final selection of features from example documents may be determined by a feature-scoring function that ranks the terms. Many possible scoring or term-selection functions might be used and are known to ordinary practitioners of the art. In one example, the following scoring function, derived from the familiar “Rocchio” scoring approach, can be used:

$$W ( t ) = IDF ( t ) \frac{{\sum }_{D} {TF}_{D} ( t )}{N p}$$

Here the score W(t) of a term “t” in a document set is a function of the inverse document frequency (IDF) of the term t in the set of documents (or sub-documents), or in a reference corpus, the frequency count TF_{D} of t in a given document D chosen for probe formation, and the total number of documents (or sub-documents) Np chosen to form the probe, where the sum is over all the documents (or sub-documents) chosen to form the probe. IDF is defined as
IDF(t)=log₂(N/nₜ)+1
where N is the count of documents in the set and nₜ is the count of the documents (or sub-documents) in which t occurs.

Once scores have been assigned to features in the document set, the features can be ranked and all or a subset of the features can be chosen to use in the feature profile for the set. For example, a predetermined number (e.g., 10, 20, 50, 100, etc.) of features for the feature profile can be chosen in descending order of score such that the top-ranked terms are used for the feature profile.

Optionally, at step 105 an additional probe P′ can be generated based on the probe P and based on a feature vector used to form the ranked set of documents, e.g., such as described above For example, the additional probe P′ could be a combination (e.g., a weighted combination) of some or all of the features of the probe P and some or all of the features of the feature vector. The additional probe P′ could then be used as a query over the available documents. It will be appreciated that such a search is “based on” both probes since the additional probe P′ is based on the earlier probe P.

At step 106, documents are found that satisfy a similarity condition from among available documents using a search based upon the probe (P, P′). Documents previously associated with a cluster of documents are not included among the available documents. For example, the probe itself (e.g., a profile of terms) could be used as a query over the available documents. The documents that satisfy the similarity condition can be referred to as “similar documents” for convenience. In this regard, a measure of the closeness or similarity between the probe and another document(s) (similarity score) can be generated using a suitable process (referred to as a similarity process for convenience), and the measure of closeness can be evaluated to determine whether it satisfies a similarity condition, e.g., meets or exceeds a predetermined threshold value. The threshold could be set at zero, if desired, i.e., such that documents that provide any non-zero similarity score are considered similar, or the threshold can be set at a higher value. As with other thresholds described herein generally, determining an appropriate threshold for a similarity score is within the purview of ordinary practitioners in the art and can be done, for example, by running the similarity process on sample or reference document sets to evaluate which thresholds produce acceptable results, by evaluating results obtained during execution of the similarity and making any needed adjustments (e.g., using feedback based on the number of similar documents identified is considered sufficient), or based on experience. As referred to herein, similarity can be viewed as a measure of the closeness or similarity between a reference document or probe and another document or probe. A similarity process can be viewed as a process that measures similarity of two vectors. In addition, the similarity scores of the responding documents can be normalized, e.g., to the similarity score of the highest scoring documents of the responding documents, and by other suitable methods that will be apparent to those of ordinary practitioners in the art.

It will be appreciated that the document S can be one of the available documents such that the document S can be among those “searched” using the probe at step 106. Alternatively, since the probe is based, at least in part, on the document S, it is not necessary to include document S (if it is one of the available documents) in a search using the probe, since it can be assumed that document S will be one of the documents in the particular cluster that is formed. If document S is one of the available documents, both of these possibilities are intended to be embraced by the language herein “finding documents that satisfy a similarity condition using the probe from among the available documents” or similar language. Of course, as noted above, it is not necessary that the document S be one of the available documents.

Various methods for evaluating similarity between two vectors (e.g., a probe and a document) are known to ordinary practitioners in the art. In one example, described in U.S. Patent Application Publication No. 2004/0158569, a vector-space-type scoring approach may be used. In a vector-space-type scoring approach, a score is generated by comparing the similarity between a profile (or query) Q and the document D and evaluating their shared and disjoint terms over an orthogonal space of all terms. Such a profile is analogous to a probe referred to above. For example, the similarities score can be computed by the following formula (though many alternative similarity functions might also be used, which are known in the art):

$$S ( {Q}_{i} , {D}_{j} ) = \frac{{Q}_{i} \cdot {D}_{j}}{\vert {Q}_{i} \vert \cdot \vert {D}_{j} \vert} = \frac{{\sum }_{k = 1}^{t} ( {q}_{ik} \cdot {d}_{jk} )}{\sqrt{{\sum }_{k = 1}^{t} {q}_{ik}^{2}} \cdot \sqrt{{\sum }_{k = 1}^{t} {d}_{jk}^{2}}}$$

where Qᵢ refers to terms in the profile and Dⱼ refers to terms in the document. Evaluating the expression above (or like expressions known in the art) provides a numerical measure of similarity (e.g., expressed as a decimal fraction). Then, as noted above, such a measure of similarity can be evaluated to determine whether it satisfies a similarity condition, e.g., meets or exceeds a predetermined threshold value. Thus, it will be appreciated that the similar documents found at step 206 can have scores that allow them to be ranked in terms of similarity to the probe P.

At step 108, some or all of the documents that satisfy the similarity condition (similar documents) are associated with a particular cluster of documents. The association can be done, for example, by recording the status of the documents that satisfy the similarity condition in the same database that stores the set of documents, or in a different database, using, for example, appropriate pointers, marks, flags or other suitable indicators. For example, a list of the titles and/or suitable identification codes for the set documents can be stored in any suitable manner (e.g., a list), and an appropriate field in the database can be marked for a given document identifying the cluster to which it belongs, e.g., identified by cluster number and/or a suitable descriptive title or label for the cluster. The documents of the cluster could also be recorded in their own list in the database, if desired. It will be appreciated that it is not necessary to record or store all of the contents of the documents themselves for purposes of association with the cluster; rather, the information used to associate certain documents with certain clusters can contain a suitable identifier that identifies a given document itself as well as the cluster to which it is associated, for example. It is possible that the particular cluster may contain only the similar documents, or it is possible that the particular cluster may also contain additional documents beyond the similar documents (e.g., if it was known that at least some other documents should be associated with the cluster prior to initiating the method 100). This aspect is applicable for clusters identified by any of the exemplary approaches disclosed herein.

As noted above, just some as opposed to all of the similar documents identified at step 106 can be associated with a cluster at step 108. Identifying some, as opposed to all of the similar documents, can be accomplished using a variety of approaches. For example, a predetermined percentage of the top scoring similar documents may be identified (e.g., top 80%, top 70%, top 60%, top 50%, top 40%, top 30%, top 20%, etc.), wherein it will be appreciated that the scores of the similar documents can be determined at step 106. As another example, fewer than all similar documents could be selected by imposing another more stringent similarity condition (e.g., a higher threshold than that referred to in step 106). Also, if a “cluster boundary” the similar documents is generated, e.g., by defining the boundary to be a function of cluster quality (similarity of documents within a cluster) and specified desired cluster precision, then only the similar documents within the boundary can be selected to be in the cluster. It will be appreciated that other approaches for identifying fewer than all of the similar document for association with a cluster can also be used.

At step 110, it is determined whether a halting condition is satisfied. For example, the method 100 could be halted after the entire set of documents is clustered, after a predetermined number of clusters has been created, after a predetermined percentage of the documents in the set of documents has been clustered, after a predetermined number of clusters of a minimum predetermined size has been created, or after a predetermined time interval has been exceeded. Other conditions can also be used as will be appreciated by ordinary practitioners in the art. If the halting condition is not satisfied (i.e., clustering should continue), steps 102-108 are repeated to form at least one other cluster. In this regard, another probe is generated from a different document S, and another similarity condition is utilized to find similar documents for a new cluster. The other similarity condition of the next iteration can be the same as the previous similarity condition, or it can be different from the previous similarity condition. It can be desirable to change (e.g., raise or lower) the similarity condition as iterations proceed to compensate for the removal of documents associated with previous iterations of clustering. At each iteration of cluster formation, the status of which documents are “available” can be updated so that documents associated with a cluster are no longer considered available documents. If documents of the set of ranked documents are among the documents of the set of documents being clustered, any documents associated with a cluster can be removed from the ranked set of documents. If the documents of the ranked set are not among the set of documents, the document S can be marked “used” such that it is not selected from the ranked set in another iteration of cluster formation. Optionally, even if the ranked set of documents is not among the set of documents being clustered, a given document S of the ranked set from which a cluster is generated can be added to that cluster.

If desired, similar documents of a given cluster can be ranked (e.g., listed in ranked order in a database) as the given cluster is identified. Finding the similar documents using methods that generate scores or weights, such as discussed above, can automatically provide ranking information. Also, the method 100 can comprise providing an identifier (referred to as a “content identifier” for convenience) that describes the content of a given cluster. For example, the title of the highest ranking document of a given cluster could be used as the content identifier. As another example, all or some terms (or description of features) of the probe could be used as the content identifier, or all or some terms of a new probe generated from multiple close documents that satisfy another similarity condition could be used as the content identifier. These aspects apply to the other exemplary methods disclosed herein as well.

As noted above, the document S is selected from a ranked set of documents, and various ways of generating such a ranked set can be used, including those mentioned above and others that will be apparent to ordinary practitioners in the art. Another exemplary method for generating such a ranked set (e.g., a ranked list) can be based upon multiple queries over the set of documents. In particular, for all or some of the documents in the set of documents, a query can be executed using a probe formed from that document over the set of documents, yielding a list of responsive documents ranked according to their similarity scores. For each set of responsive documents, a collective score of the responsive documents can be generated, e.g., by summing the scores of each responsive document, or by calculating the average response score, etc. This collective score can then be associated with the particular document whose probe produced a given set of responsive documents. Those collective scores can then be ranked and normalized against the highest collective score. Then, those documents with associated collective scores above a predetermined threshold can be selected as the set of ranked documents from which to form clusters of documents, wherein individual documents S can be selected from the ranked set of documents beginning with the highest ranking of the ranked set of documents and proceeding to lower ranking candidate documents.

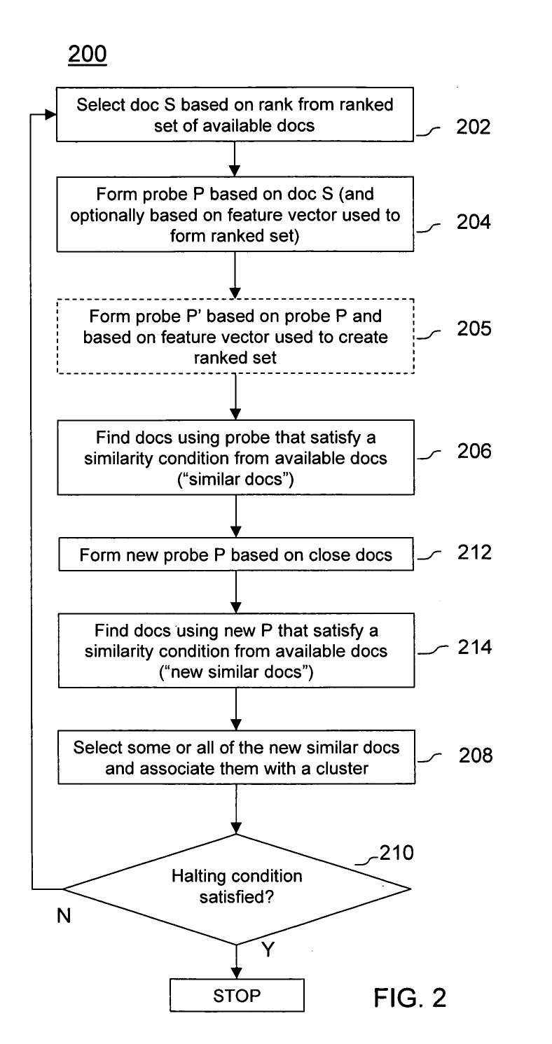

According to another aspect of the invention, FIG. 2 illustrates an exemplary method 200 for identifying clusters of similar documents. Steps 202-206 are analogous to steps 102-106 previously described, and these steps do not require further discussion. At the point of step 206, a set of similar documents has been identified using a probe (P or P′, where P′ is based upon P).

From step 206, the process proceeds to step 212, where a new probe is formed based on close documents of the similar documents (a subset of the similar documents), which will typically include the document S. Any of the exemplary approaches previously described herein for forming probes (or other suitable approach) can be used at step 212. The “close documents” (a label used for convenience herein) used in forming the new probe P can be those documents of the similar documents (found at step 206) that satisfy another similarity condition (e.g., a more stringent threshold than that used in identifying the similar documents, a predetermined number or percentage of the top ranking similar documents, etc.). Since the similar documents found at step 206 can already have rank scores, the close documents can simply be designated as such in view of those scores. In other words, a separate query or other type of search is not necessary to identify the close documents.

At step 214, documents are found using the new P that satisfy a similarity condition from among the available documents. These documents can be referred to as “new similar documents” for convenience to avoid confusion with the “similar documents” found at step 206, considering that the new similar documents are found using a new probe P. Step 214 can be carried out as described in connection with steps 106 and 206 of FIGS. 1 and 2, for example.

As is true with the other exemplary methods described herein, the similarity conditions at steps 206 and 214 can change as iterations of cluster formation proceed. For example, an initial value of the similarity condition at step 214 can be a function of the object density in the neighborhood of the document S and, optionally, a function of a specified minimum cluster size. The effect is to select a number of documents close to the probe. For example, the threshold of the similarity condition can be adjusted based on feedback (e.g., whether cluster formation is meeting expectations) or changed by predetermined amounts as a function of iteration. For example, as iterations proceed, it is possible to either raise or lower the similarity condition to compensate for the removal of similar documents as clustering proceeds. Raising the similarity condition might be done to achieve more precise clusters as clustering proceeds; lowering the similarity condition might be done to speed the process to completion after a certain number of clusters have been obtained or after a certain percentage of the set of documents has been clustered. It will also be appreciated that, although steps 206 and 214 each refer to a similarity condition, these similarity conditions may or may not be the same. These comments are applicable to other exemplary methods illustrated herein as well.

At step 208, some or all of the similar documents identified at step 214 are associated with a cluster. This step can be carried out as discussed in connection with step 108 of FIG. 1. In addition to the ways discussed in connection with step 108 for identifying or selecting some, as opposed to all of the similar documents, any of the approaches described above for identifying “close documents” can be used to select some of the similar documents for association with a cluster.

At step 210, a determination is made as to whether a halting condition is satisfied. This step is analogous to step 110 of FIG. 1 and does not need to be described further. If the halting condition is satisfied (i.e., no more clustering is needed or desired), the process ends. If the halting condition is not satisfied, the process proceeds back to step 202 of FIG. 2, and steps 202-214 are repeated as discussed above.

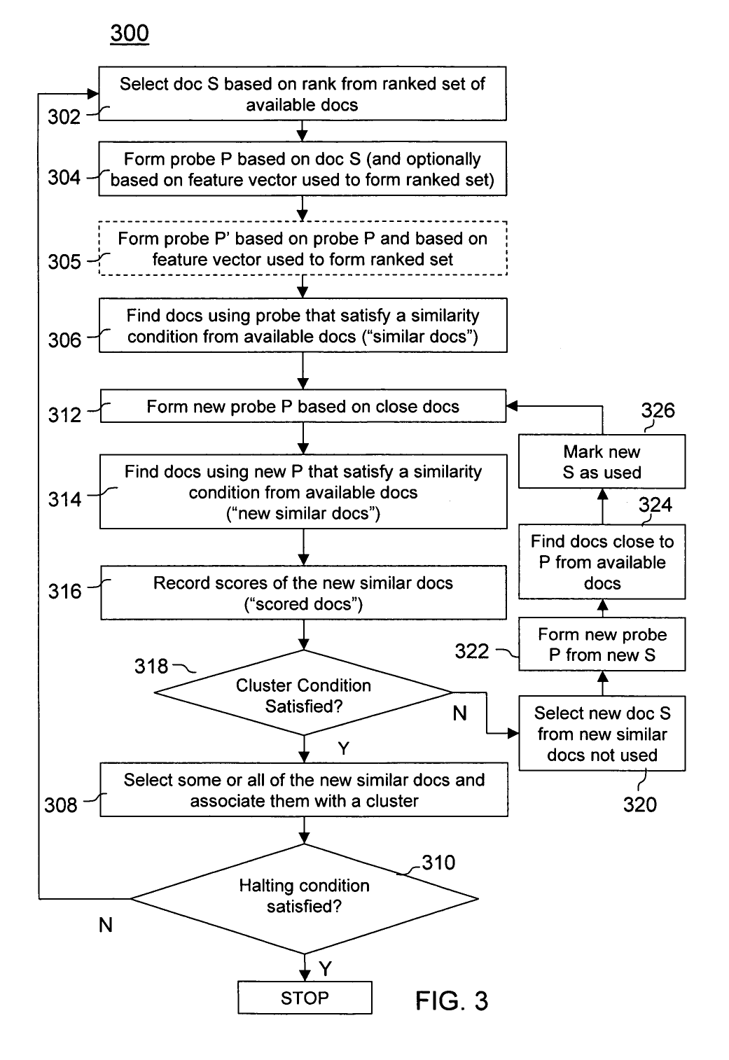

FIG. 3 illustrates an exemplary method 300 for identifying clusters of similar documents. Steps 302-314 are analogous to steps 202-214 of FIG. 2, respectively, and no further discussion of those steps as an initial matter is needed. FIG. 3 adds steps 316-326.

At step 316, the similarity scores of the new similar documents are recorded or updated as appropriate (e.g., saved/updated in a database, which can be the same database that maintains the clustering information relating to the set of documents, or a different database). These similarity scores can be provided by exemplary processes for finding the similar documents as previously discussed. Optionally, the new similar documents can be sorted according to their similarity scores. These documents can be referred to as “scored documents” for convenience, but it will be apparent that they are also considered the new similar documents, as discussed above. Considering the loop between steps 312 and 326, a given document found as a similar document (or new similar document) could be scored multiple times. If a given document has already been scored and receives a new score in any iteration of the loop, the new score can be added or otherwise accumulated to the old score for that document, and the accumulated score associated with that document can be updated by recording the accumulated score.

At step 318, it is determined whether a given set of scored documents, which are essentially a candidate cluster at this stage, satisfies a cluster condition. If the cluster condition is satisfied, the process proceeds to step 308 where some or all of the scored documents (new similar documents) are associated with a cluster, such as has been described previously herein. The process then continues step 310 to determine whether to halt clustering.

If the cluster condition at step 318 is not satisfied, the process proceeds from step 318 to step 320. At step 320 a new document S is selected from the new similar documents identified at step 314 (e.g., the new document S can be the highest ranking of the new similar documents, or a document that satisfies another condition such as described elsewhere herein) as long as it is not marked “used,” meaning it has not been used previously to form a probe. At step 322, a new probe P is formed based on the new document S using any suitable method for probe formation such as described herein. At step 324, documents that satisfy a similarity condition are found using P from among the available documents, such as described elsewhere herein. At step 326, the new document S is marked as “used” or is flagged in any other suitable manner to indicate that the document S has been previously used to form a probe so that it is not used again in a subsequent iteration of steps 312-326 (step 326 could occur at a different location in the ordering of steps). These resulting similar documents are then used as input to step 312, i.e., they can be used as the “close docs” referred to at step 312, or a subset of the similar documents found at step 324 can be used as the “close docs” in step 312. At step 312, a further new probe P is formed based upon the newly found similar or close documents from step 324. Steps 312-318 are then executed as described above, and if the cluster condition is still not satisfied, the process will proceed again to steps 320-326 to provide input again to step 312. The looping between steps 312-326 can be viewed as a process where the probe is iteratively refined using at least one new document (typically more than one) for forming the refined probe and where the emerging cluster is refined.

Any of a variety of cluster conditions can be utilized at step 318 in this process. For example, one cluster condition can be whether all of the documents of the emerging cluster (i.e., those found at step 314) have been used as the new document S at step 320. If yes, the process proceeds to step 308, and the looping through steps 312-326 terminates. As another example, the cluster condition can be whether the size of the emerging cluster has saturated after a predetermined number of iterations through the loop of steps 312-326 (e.g., N consecutive loops do no find new documents at step 314). As another example, the cluster condition can be whether a predetermined number of iterations through the loop of steps 312-326 has occurred. Other conditions can also be used as will be appreciated by ordinary practitioners in the art.

In addition, the similarity condition at step 314 can be changed such as described elsewhere herein (e.g., the threshold of the condition can be adjusted based on feedback or changed by predetermined amounts as a function of iteration of clustering operations). In addition, it can also be desirable to further adjust the similarity condition at step 314 in view of the probe/cluster refinement loop of steps 312-326. In particular, it can be desirable to further adjust the similarity condition used at step 314 as a function of score profile of the scored documents in a given iteration of the probe/cluster refinement loop of steps 312-326 (e.g., a threshold for the cluster condition can be incremented by positive or negative amounts depending upon the score profile of the scored documents).

With regard to step 308, various approaches have been previously described for selecting only some, as opposed to all of the scored or similar documents for inclusion in a cluster. One approach previously mentioned involves detecting documents at the “cluster boundary” of the scored documents (which can be considered an emerging cluster), and eliminating those documents such that they are not associated with the cluster. In the context of FIG. 3, documents at the cluster boundary can be identified, for example, as those documents seen in less than a certain percentage of cluster refining probe responses through iterations of steps 312-326. These boundary documents can be eliminated so that they are not associated with the cluster.

Exemplary methods described herein can have notable advantages compared to known clustering approaches. For example, if random selection is used to choose a document from which to generate a probe for clustering, the most coherent and largest clusters tend to be generated first because the randomly selected document is likely a member of one of the larger thematic groups of the set of documents. If a seed list is established, selecting the highest (or a highly ranking) seed document from which to generate a probe also tends to generate the largest and most coherent clusters first. For each cluster, the methods described herein can rank documents according to their importance to the cluster. Meaningful labels or identifiers of cluster content for a given cluster can be generated from terms or descriptions of features from the probe that created the cluster. The exemplary methods do not require processing the entire set of documents to achieve final clusters; rather, final, complete clusters are generated during each iteration of cluster formation. Thus, even if the process is aborted prematurely, final results for what are likely the most important clusters can be obtained. The methods are computationally efficient and fast because each cluster is removed in a single pass, leaving fewer documents to process during the next iteration of cluster formation.

### HARDWARE OVERVIEW

FIG. 4 illustrates a block diagram of an exemplary computer system upon which an embodiment of the invention may be implemented. Computer system 1300 includes a bus 1302 or other communication mechanism for communicating information, and a processor 1304 coupled with bus 1302 for processing information. Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Computer system 1300 further includes a read only memory (ROM) 1308 or other static storage device coupled to bus 1302 for storing static information and instructions for processor 1304. A storage device 1310, such as a magnetic disk or optical disk, is provided and coupled to bus 1302 for storing information and instructions.

Computer system 1300 may be coupled via bus 1302 to a display 1312 for displaying information to a computer user. An input device 1314, including alphanumeric and other keys, is coupled to bus 1302 for communicating information and command selections to processor 1304. Another type of user input device is cursor control 1315, such as a mouse, a trackball, or cursor direction keys for communicating direction information and command selections to processor 1304 and for controlling cursor movement on display 1312.

The exemplary methods described herein can be implemented with computer system 1300 for carrying out document clustering. The clustering process can be carried out by processor 1304 by executing sequences of instructions and by suitably communicating with one or more memory or storage devices such as memory 1306 and/or storage device 1310 where the set of documents and clustering information relating thereto can be stored and retrieved, e.g., in any suitable database. The processing instructions may be read into main memory 1306 from another computer-readable carrier, such as storage device 1310. However, the computer-readable carrier is not limited to devices such as storage device 1310. For example, the computer-readable carrier may include a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read, including any modulated waves/signals (such as radio frequency, audio frequency, or optical frequency modulated waves/signals) containing an appropriate set of computer instructions that would cause the processor 1304 to carry out the techniques described herein. Execution of the sequences of instructions causes processor 1304 to perform process steps previously described herein. In alternative embodiments, hard-wired circuitry may be used in place of or in combination with software instructions to implement the exemplary methods described herein. Thus, embodiments of the invention are not limited to any specific combination of hardware circuitry and software.

Computer system 1300 can also include a communication interface 1316 coupled to bus 1302. Communication interface 1316 provides a two-way data communication coupling to a network link 1320 that is connected to a local network 1322 and the Internet 1328. It will be appreciated that the set of documents to be clustered can be communicated between the Internet 1328 and the computer system 1300 via the network link 1320, wherein the documents to be clustered can be obtained from one source or multiples sources. Communication interface 1316 may be an integrated services digital network (ISDN) card or a modem to provide a data communication connection to a corresponding type of telephone line. As another example, communication interface 1316 may be a local area network (LAN) card to provide a data communication connection to a compatible LAN. Wireless links may also be implemented. In any such implementation, communication interface 1316 sends and receives electrical, electromagnetic or optical signals which carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the “Internet” 1328. Local network 1322 and Internet 1328 both use electrical, electromagnetic or optical signals which carry digital data streams. The signals through the various networks and the signals on network link 1320 and through communication interface 1316, which carry the digital data to and from computer system 1300, are exemplary forms of modulated waves transporting the information.

Computer system 1300 can send messages and receive data, including program code, through the network(s), network link 1320 and communication interface 1316. In the Internet 1328 for example, a server 1330 might transmit a requested code for an application program through Internet 1328, ISP 1326, local network 1322 and communication interface 1316. In accordance with the invention, one such downloadable application can provides for carrying out document clustering as described herein. Program code received over a network may be executed by processor 1304 as it is received, and/or stored in storage device 1310, or other non-volatile storage for later execution. In this manner, computer system 1300 may obtain application code in the form of a modulated wave, which is intended to be embraced within the scope of a computer-readable carrier.

Components of the invention may be stored in memory or on disks in a plurality of locations in whole or in part and may be accessed synchronously or asynchronously by an application and, if in constituent form, reconstituted in memory to provide the information required for retrieval or filtering of documents.

While this invention has been particularly described and illustrated with reference to particular embodiments thereof, it will be understood by those skilled in the art that changes in the above description or illustrations may be made with respect to form or detail without departing from the spirit or scope of the invention. For example, while flow diagrams of the figures herein show process steps occurring in exemplary orders, it will be appreciated that all steps do not necessarily need to occur in the orders illustrated.

What is claimed is:

1. A method for identifying clusters of similar documents from among a set of documents, the method comprising:
(a) selecting a particular document based on rank from among a ranked set of documents;
(b) generating a probe based on the particular document, the probe comprising one or more features;
(c) finding documents that satisfy a similarity condition from among available documents of the set of documents using a search based upon the probe;
(d) associating some or all documents found with a particular cluster of documents; and
(e) repeating steps (a)-(d) using another probe as the probe and using another similarity condition as the similarity condition until a halting condition is satisfied to identify at least one other cluster of documents,
wherein those documents of the set of documents previously associated with a cluster of documents are not included among the available documents.

2. The method of claim 1, wherein selecting the particular document based on rank comprises selecting the highest ranked document of the ranked set of documents.

3. The method of claim 1, wherein generating the probe based on the particular document comprises generating the probe based on the particular document and based on a feature vector used to generate the ranked set of documents.

4. The method of claim 1, comprising generating an additional probe based on said probe and based on a feature vector used to generate the ranked set of documents, such that finding documents in step (c) is based upon said probe and said additional probe.

5. The method of claim 1, further comprising:
generating a new probe based on a subset of the documents found at step (c); and
finding documents from among the available documents using a search based upon the new probe,
wherein the associating in step (d) is based on documents found using the search based upon the new probe.

6. The method of claim 1, wherein said another similarity condition is the same as the similarity condition.

7. The method of claim 1, wherein the probe comprises the particular document.

8. The method of claim 1, wherein the probe comprises a subset of features selected from the particular document.

9. The method of claim 1, wherein the probe comprises a subset of features selected from multiple documents of the set of documents, and wherein the subset of features includes features of the particular document.

10. The method of claim 1, comprising ranking the documents of said particular cluster and ranking the documents of said at least one other cluster.

11. The method of claim 1, comprising generating an identifier using the probe that describes content of the particular cluster of documents.

12. The method of claim 1, comprising refining the probe by reforming the probe using at least one new document from the set of documents.

13. An apparatus for identifying clusters of similar documents from among a set of documents, comprising:
a memory; and
a processor coupled to the memory, wherein the processor is configured to execute the steps of:
(a) selecting a particular document based on rank from among a ranked set of documents;
(b) generating a probe based on the particular document, the probe comprising one or more features;
(c) finding documents that satisfy a similarity condition from among available documents of the set of documents using a search based upon the probe;
(d) associating some or all documents found with a particular cluster of documents; and
(e) repeating steps (a)-(d) using another probe as the probe and using another similarity condition as the similarity condition until a halting condition is satisfied to identify at least one other cluster of documents,
wherein those documents of the set of documents previously associated with a cluster of documents are not included among the available documents.

14. The apparatus of claim 13, wherein selecting the particular document based on rank comprises selecting the highest ranked document of the ranked set of documents.

15. The apparatus of claim 13, wherein generating the probe based on the particular document comprises generating the probe based on the particular document and based on a feature vector used to generate the ranked set of documents.

16. The apparatus of claim 13, comprising generating an additional probe based on said probe and based on a feature vector used to generate the ranked set of documents, such that finding documents in step (c) is based upon said probe and said additional probe.

17. The apparatus of claim 13, further comprising:
generating a new probe based on a subset of the documents found at step (c); and
finding documents from among the available documents using a search based upon the new probe,
wherein the associating in step (d) is based on documents found using the search based upon the new probe.

18. The apparatus of claim 13, wherein said another similarity condition is the same as the similarity condition.

19. The apparatus of claim 13, wherein the probe comprises the particular document.

20. The apparatus of claim 13, wherein the probe comprises a subset of features selected from the particular document.

21. The apparatus of claim 13, wherein the probe comprises a subset of features selected from multiple documents of the set of documents, and wherein the subset of features includes features of the particular document.

22. The apparatus of claim 13, comprising ranking the documents of said particular cluster and ranking the documents of said at least one other cluster.

23. The apparatus of claim 13, comprising generating an identifier using the probe that describes content of the particular cluster of documents.

24. The apparatus of claim 13, comprising refining the probe by reforming the probe using at least one new document from the set of documents.

25. A computer readable carrier comprising processing instructions adapted to cause a processor to execute the method of claim 1.
